(19) United States
(12) Patent Application Publication
(10) Pub. No.: US 2026/0042937 A1
(43) Pub. Date: Feb. 12, 2026

(54) LAMINATE AND ADHESIVE FILM

(71) Applicant: AGC INC., Tokyo (JP)

(72) Inventor: Koichi ODA, Chiyoda-ku (JP)

(73) Assignee: AGC INC., Tokyo (JP)

(21) Appl. No.: 19/360,449

(22) Filed: Oct. 16, 2025

Related U.S. Application Data
(63) Continuation of application No. PCT/JP2024/015142, filed on Apr. 16, 2024.

(30) Foreign Application Priority Data
Apr. 18, 2023 (JP) 2023-068088

(51) Int. Cl. C09J 7/24; B32B 5/02; B32B 27/12; B32B 27/30; B32B 27/32; C09J 11/06

(52) U.S. Cl. CPC C09J 7/245; B32B 5/024; B32B 27/12; B32B 27/306; B32B 27/322; C09J 11/06; B32B 2255/02; B32B 2255/26; B32B 2307/7376; B32B 2405/00; C09J 2301/408

(57) ABSTRACT

A laminate includes, in this order: a fluororesin layer containing an ethylene-tetrafluoroethylene copolymer; an adhesive layer containing an aminosilane coupling agent; and a resin substrate containing an ultraviolet absorber and a resin.

### CROSS-REFERENCE TO RELATED APPLICATIONS

This application is a Continuation application of International Application No. PCT/JP2024/015142, filed Apr. 16, 2024, the disclosure of which is incorporated herein by reference in its entirety. Further, this application claims priority from Japanese Patent Application No. 2023-068088, filed Apr. 18, 2023, the disclosure of which is incorporated herein by reference in its entirety.

### TECHNICAL FIELD

The present invention relates to a laminate and an adhesive film.

### BACKGROUND ART

A laminate provided with a fluororesin film having excellent properties such as weather resistance and water- and oil-repellency as a protective film is utilized in a wide range of fields. As such a laminate, for example, Patent Literature 1 discloses one in which the surface of a vinylidene fluoride film is plasma discharge treated, and the treated surface is laminated with a substrate.

### CITATION LIST

### Patent Literature

Patent Literature 1: Japanese Patent Application Laid-Open (JP-A) No. 2013-33880

### SUMMARY OF INVENTION

### Technical Problem

In recent years, it has been desired to use laminates outdoors for long periods, and there is a demand for long-term weather resistance in laminates. For example, using a laminate having excellent long-term weather resistance has the advantage of reducing the replacement frequency. In order to meet this demand, the use of an ethylene-tetrafluoroethylene copolymer as the fluororesin has been considered. A fluororesin layer using an ethylene-tetrafluoroethylene copolymer exhibits markedly improved weather resistance compared to other fluororesin layers.

However, due to the marked improvement in the long-term weather resistance of the fluororesin layer, it has become apparent that, in laminates bonded by conventional methods, the bonding portion between the fluororesin layer and the substrate is insufficient in terms of long-term weather resistance and tends to peel off in weather resistance tests.

The disclosure has been made in view of the above circumstances, and an object thereof is to provide a laminate and an adhesive film having excellent long-term weather resistance.

### Solution to Problem

Specific means for achieving the above object are as follows.

<1> A laminate, including, in this order:
a fluororesin layer containing an ethylene-tetrafluoroethylene copolymer;
an adhesive layer containing an aminosilane coupling agent; and
a resin substrate containing an ultraviolet absorber and a resin.

<2> The laminate according to <1>, in which a visible light transmittance from the fluororesin layer to the adhesive layer is 85% or more.

<3> The laminate according to <1> or <2>, in which the resin in the resin substrate includes at least one selected from the group consisting of an ethylene-vinyl acetate copolymer resin and a modified polyethylene resin.

<4> The laminate according to any one of <1> to <3>, in which a total content of the ultraviolet absorber and the resin in the resin substrate is 99% by mass or more.

<5> The laminate according to any one of <1> to <4>, in which an amount of amino groups contained in the adhesive layer is from 0.01 to 2.5 mmol/m².

<6> The laminate according to any one of <1> to <5>, in which an average thickness of the adhesive layer is 1 μm or less.

<7> The laminate according to any one of <1> to <6>, in which a content of the ethylene-tetrafluoroethylene copolymer in the fluororesin layer is 90% by mass or more.

<8> The laminate according to any one of <1> to <7>, in which the fluororesin layer further contains a pigment.

<9> The laminate according to any one of <1> to <8>, which is at least one selected from the group consisting of protective films for front sheets of solar cell modules, protective films for digital signage, protective films for signboards, and protective films for interior materials.

<10> An adhesive film, including:
a fluororesin layer containing an ethylene-tetrafluoroethylene copolymer; and
an adhesive layer containing an aminosilane coupling agent, in which
a visible light transmittance is 85% or more.

<11> An adhesive film, including:
a fluororesin layer containing an ethylene-tetrafluoroethylene copolymer; and
a layer containing an aminosilane coupling agent, in which:
the adhesive film is used for at least one selected from the group consisting of protective films for front sheets of solar cell modules, protective films for digital signage, protective films for signboards, and protective films for interior materials.

### Advantageous Effects of Invention

According to one aspect of the disclosure, it is possible to provide a laminate and an adhesive film having excellent long-term weather resistance.

### BRIEF DESCRIPTION OF DRAWINGS

FIG. 1 is a schematic cross-sectional view showing an example of a laminate of the disclosure.

FIG. 2 is a schematic cross-sectional view showing another example of the laminate of the disclosure.

### DESCRIPTION OF EMBODIMENTS

Hereinafter, an embodiment of the disclosure will be described in detail. However, the disclosure is not limited to the following embodiments. In the following embodiments, the constituent elements (including element steps and the like) are not essential unless otherwise specified. The same applies to numerical values and ranges thereof, and the disclosure is not limited thereto.

In the disclosure, the numerical ranges indicated using “to” include the numerical values before and after “to” as the minimum and maximum values, respectively.

In the numerical ranges described step by step in the disclosure, the upper limit value or the lower limit value of one numerical range may be replaced with the upper limit value or the lower limit value of another numerical range described step by step. In the numerical ranges described in the disclosure, the upper limit value or the lower limit value of the numerical ranges may be replaced with the values shown in the examples.

In the disclosure, each component may contain plural types of corresponding substances. When plural types of substances corresponding to each component are present in the composition, the content or content amount of each component means the total content or content amount of the plurality of types of substances present in the composition unless otherwise specified.

In the disclosure, the particles corresponding to each component may include plural types of particles. When there are plural types of particles corresponding to each component in the composition, the particle diameter of each component means a value for a mixture of the plurality of types of particles present in the composition unless otherwise specified.

In the disclosure, the “unit” of a polymer means a portion derived from a monomer that is present in the polymer and constitutes the polymer. A unit obtained by chemically converting the structure of a certain unit after formation of a polymer is also referred to as a unit. In some cases, a unit derived from an individual monomer is referred to by a name in which “unit” is added to the monomer name.

In the disclosure, films and sheets are referred to as “films” regardless of their thickness.

In the disclosure, “(meth)acrylic” means at least one of acrylic and methacrylic.

When an embodiment is described with reference to the drawings in the disclosure, the structure of the embodiment is not limited to the structure shown in the drawings. The sizes of the members in each drawing are conceptual, and the relative relationship between the sizes of the members is not limited thereto.

In the disclosure, long-term weather resistance means excellent adhesive strength when exposed to ultraviolet rays for 500 hours in a weather resistance test described later.

### <Laminate>

The laminate of the disclosure includes a fluororesin layer containing an ethylene-tetrafluoroethylene copolymer (hereinafter also referred to as “ETFE”), an adhesive layer containing an aminosilane coupling agent, and a resin substrate containing an ultraviolet absorber and a resin in this order.

By adopting the above structure, a laminate having excellent long-term weather resistance is obtained. The reason for this is not clear, but is presumed as follows.

By employing a fluororesin layer containing ETFE, the long-term weather resistance of the fluororesin layer itself is improved. By employing as the adhesive layer, a layer containing an aminosilane coupling agent, the adhesive strength between the fluororesin layer containing ETFE and the resin substrate is improved. When the resin substrate contains the ultraviolet absorber, ultraviolet rays incident on the resin substrate side are absorbed, and the long-term weather resistance of the entire laminate is improved. Even when the ultraviolet ray is incident from the fluororesin layer side, the ultraviolet ray transmitted through the fluororesin layer and the adhesive layer and reaching the resin substrate is absorbed, and reflection of the ultraviolet ray toward the fluororesin layer and the adhesive layer side is suppressed, and thus deterioration of the fluororesin layer and the adhesive layer is suppressed.

Each constituent member and the components thereof will be described below.

### [Fluororesin Layer]

The fluororesin layer includes ETFE.

ETFE is a copolymer having tetrafluoroethylene units (hereinafter referred to as TFE units) and ethylene units. One type of ETFE may be used alone, or two or more types thereof may be used in combination.

A molar ratio of the TFE unit to the ethylene unit (TFE unit/ethylene unit) in the ethylene-tetrafluoroethylene copolymer is preferably from 20/80 to 80/20, more preferably from 30/70 to 70/30, and still more preferably from 40/60 to 60/40.

ETFE may have other monomer units in addition to the TFE units and the ethylene units. A ratio of the other monomer units is preferably 10% by mole or less, more preferably 6% by mole or less, and still more preferably 3% by mole or less with respect to the total (100% by mole) of all the monomer units of ETFE.

Other monomers may be any monomer capable of copolymerizing with tetrafluoroethylene and ethylene, and examples thereof include:
fluoroethylenes such as CF₂═CFCl and CF₂═CH₂ (excluding TFE);
C3 to C5 perfluoroolefins such as hexafluoropropylene and octafluorobutene-1;
polyfluoroalkylethylenes represented by X(CF₂)ₙCY═CH₂ (where X and Y are each independently a hydrogen atom or a fluorine atom, and n represents an integer from 2 to 8);
perfluorovinyl ethers represented by R(OCFXCF₂)ₘOCF═CF₂ (where R is a perfluoroalkyl group having 1 to 6 carbon atoms, X is a fluorine atom or a trifluoromethyl group, and m represents an integer from 0 to 5);
perfluorovinyl ethers having a group readily convertible into a carboxylic acid group or a sulfonic acid group, such as CH₃OC(═O)CF₂CF₂CF₂OCF═CF₂ and FSO₂CF₂CF₂OCF(CF₃)CF₂OCF═CF₂;
perfluorovinyl ethers having two or more unsaturated bonds, such as CF₂═CFOCF₂CF═CF₂ and CF₂═CFO(CF₂)₂CF═CF₂;
fluorine-containing monomers having an aliphatic ring structure, such as perfluoro(2,2-dimethyl-1,3-dioxole), 2,2,4-trifluoro-5-trifluoromethoxy-1,3-dioxole, and perfluoro(2-methylene-4-methyl-1,3-dioxolane); and
olefins having 3 or more carbon atoms, such as C3 olefins (propylene and the like) and C4 olefins (butylene, isobutylene, and the like).

In the polyfluoroalkylethylenes represented by X(CF₂)ₙCY═CH₂, n is preferably 2 to 6, and more preferably 2 to 4. Specific examples include CF₃CF₂CH═CH₂, CF₃CF₂CF₂CF₂CH═CH₂, CF₃CF₂CF₂CF₂CF═CH₂, CF₂HCF₂CF₂CF═CH₂, and CF₂HCF₂CF₂CF═CH₂.

Specific examples of perfluorovinyl ethers such as R(OCFXCF₂)ₘOCF═CF₂ include perfluoro(methyl vinyl ether), perfluoro(ethyl vinyl ether), perfluoro(propyl vinyl ether), CF₂═CFOCF₂CF(CF₃)O(CF₂)₂CF₃, CF₂═CFO(CF₂)₃O(CF₂)₂CF₃, CF₂═CFO(CF₂CF(CF₃)O)₂(CF₂)₂CF₃, and CF₂═CFOCF₂CF(CF₃)O(CF₂)₂CF₃.

As the other monomer, the polyfluoroalkyl ethylenes, hexafluoropropylene, and perfluoro(propyl vinyl ether) are preferable, and CF₃CF₂CH═CH₂, CF₃(CF₂)₃CH═CH₂, hexafluoropropylene, and perfluoro(propyl vinyl ether) are more preferable. One type of the other monomer may be used alone, or two or more types thereof may be used in combination.

A number average molecular weight of ETFE is not particularly limited, but is preferably from 100,000 to 500,000, and more preferably from 200,000 to 400,000. When the number average molecular weight of ETFE is 100,000 or more, a decrease in strength in a heat resistance test is suppressed. When the number average molecular weight of ETFE is 500,000 or less, it is easy to mold a thin film having a thickness of 20 μm or less, for example, approximately 10 μm.

The number average molecular weight of ETFE is a value obtained by the following procedure. Melt dynamic shear modulus measurement is performed using a rheometer (DAR100) manufactured by Reologica to obtain the relationship between the frequency (ω) and the dynamic elastic modulus. Next, based on the document (W. H. Tuminello, Macromolecules, 1993, 26, 499-50), the molecular weight is obtained from the frequency by fitting such that the relationship between the frequency and the molecular weight M, 1/ω=CM^{3.4} (C: constant), and converted into a differential molecular weight distribution curve to calculate the number average molecular weight. In addition, GNO (plateau elastic modulus) corresponding to the elastic modulus of the molecular weight between entanglement points is set to 3.5×10⁶ dyne/cm².

As the fluororesin layer, a fluororesin other than ETFE may be used in combination.

Examples of other fluororesins include vinyl fluoride polymers, vinylidene fluoride polymers, vinylidene fluoride-hexafluoropropylene copolymers, tetrafluoroethylene-hexafluoropropylene-vinylidene fluoride copolymers, tetrafluoroethylene-propylene copolymers, tetrafluoroethylene-vinylidene fluoride-propylene copolymers, hexafluoropropylene-tetrafluoroethylene copolymers, and perfluoro(alkyl vinyl ether)-tetrafluoroethylene copolymers. One type of the other fluororesin may be used alone, or two or more types thereof may be used in combination.

A content of ETFE with respect to the total fluororesin contained in the fluororesin layer is preferably 90% by mass or more, more preferably 95% by mass or more, still more preferably 98% by mass or more, and particularly preferably 100% by mass. That is, the fluororesin is particularly preferably ETFE.

The fluororesin layer may contain a resin other than the fluororesin.

Examples of the other resin include a (meth)acrylic resin, a polycarbonate resin, a polyethylene resin, a polypropylene resin, polyethylene terephthalate, polybutylene terephthalate, and nylon.

A content of the fluororesin in the fluororesin layer is preferably 50% by mass or more, more preferably 90% by mass or more, still more preferably 98% by mass or more, and particularly preferably 100% by mass.

The content of ETFE in the fluororesin layer is preferably 50% by mass or more, more preferably 90% by mass or more, still more preferably 98% by mass or more, and particularly preferably 100% by mass.

The fluororesin layer may contain components other than the resin. Examples of other components include copper compounds such as copper oxide and copper iodide, hydrophobizing agents, antioxidants, pigments, mica, and antibacterial agents. A content of these additives is preferably determined appropriately such that the film appearance is not deteriorated while exerting its function.

When the copper compound is contained, the heat resistance of the fluororesin layer is improved. A average particle diameter of the copper compound is preferably from 1 to 50 μm.

Examples of the antioxidants include known antioxidants such as phosphorus-containing antioxidants, phenol antioxidants, and sulfur-containing antioxidants.

Examples of the hydrophobizing agents include a silane coupling agent having an alkyl group (S1) and a silicone compound (S2).

Examples of the silane coupling agent (S1) include trialkoxysilanes such as isobutyltrimethoxysilane, hexyltrimethoxysilane, and (3,3,3-trifluoropropyl)trimethoxysilane; silazanes such as hexamethyldisilazane; and chlorosilanes such as dimethyldichlorosilane.

Among them, isobutyltrimethoxysilane is preferable.

The silicone compound (S2) is an organopolysiloxane having an organic group. The organic group is preferably an alkyl group having 4 or less carbon atoms or a phenyl group.

As the silicone compound (S2), a compound generally called silicone oil can be used. Examples of the silicone oil include straight silicone oils such as dimethyl silicone oil and phenylmethyl silicone oil, alkyl modified silicone oils, alkyl aralkyl modified silicone oils, fluorinated alkyl modified silicone oils, and methyl hydrogen silicone oils. Among them, dimethyl silicone oil is preferable from the viewpoint of cost, and phenylmethyl silicone oil is preferable from the viewpoint of heat resistance. In addition, a reactive silicone oil having highly reactive hydrogen in the molecule, such as methyl hydrogen silicone oil, is also preferable as the hydrophobizing agent.

A molecular weight of the silicone oil is preferably 1,500 or less. When the molecular weight is 1,500 or less, the oxygen atoms of the other oxide-containing layer of the composite pigment (B) and the silicone oil effectively react with each other to form a uniform and dense surface-treated layer, and the dispersibility of the composite pigment (B) in the fluororesin film is further improved.

As the silicone compound (S2), a commercially available product may be used. Examples of the dimethyl silicone oil include SH200 (product name) manufactured by Dow Corning Toray Silicone Co., Ltd., KF-96 (product name) manufactured by Shin-Etsu Chemical Co., Ltd., TSF451 (product name) manufactured by Momentive Performance Materials, and the like, which have various molecular weights (viscosities). Examples of the phenylmethyl silicone oil include SH510 (product name), SH550 (product name), and SH710 (product name) manufactured by Dow Corning Toray Silicone Co., Ltd., and KF54 (product name) manufactured by Shin-Etsu Chemical Co., Ltd. Examples of the methyl hydrogen silicone oil include KF-9901 (product name) manufactured by Shin-Etsu Chemical Co., Ltd., and SH1107 (product name) manufactured by Dow Corning Toray Silicone Co., Ltd.

The pigment may be a pigment for coloring the fluororesin layer or a pigment for reducing the transmittance of the ultraviolet region of the fluororesin layer. As the pigment, a general pigment may be applied. One type of the pigment may be used alone, or two or more types thereof may be used in combination.

From the viewpoint of improving the weather resistance of the laminate, the fluororesin layer preferably contains a pigment.

Examples of the pigment for reducing the transmittance in the ultraviolet region include black pigments typified by carbon black, blue pigments typified by cobalt oxide, red pigments typified by iron oxide, yellow pigments typified by cerium oxide, and white pigments typified by titanium oxide, silicon oxide, zinc oxide, and cerium oxide. Among them, carbon black, titanium oxide, and cerium oxide are preferable, and titanium oxide and cerium oxide are more preferable from the viewpoint of excellent ultraviolet shielding properties and excellent weather resistance.

In addition, as long as the ability of the ultraviolet shielding properties is not impaired, a pigment may be used by being coated with other pigments, inorganic substances, organic substances, and combinations thereof. For example, when the pigment contains titanium oxide, since titanium oxide has a catalytic active function, it is preferable to use composite particles of titanium oxide (hereinafter also referred to as “titanium oxide composite particles”) having a coating layer containing at least aluminum oxide on the surface of titanium oxide.

A pigment in which carrier particles are coated with a pigment or the like to form a coating layer may be used as a pigment. For example, cerium oxide composite particles having a three-layer structure of amorphous silica-cerium oxide-carrier from the outermost layer may be used as a pigment.

From the viewpoint of ultraviolet shielding properties, a content amount of the pigment in the fluororesin layer is preferably 1.0% by mass or more, more preferably 2.0% by mass or more, and particularly preferably 2.5% by mass or more. In addition, the content amount of the pigment in the fluororesin layer is preferably 15.0% by mass or less, more preferably 13.0% by mass or less, and still more preferably 11.0% by mass or less from the viewpoint of excellent kneadability when the pigment is kneaded into the fluororesin and excellent effect of hiding the substrate by the obtained adhesive film. The effect of hiding the substrate refers to that when the adhesive film and the substrate are laminated, patterns, characters, fibers, and the like of the substrate cannot be visually recognized from the fluororesin layer side of the adhesive film, and when the effect of hiding the substrate is excellent, the designability of an article obtained by laminating the adhesive film and the substrate is excellent.

A average particle diameter of the pigment is preferably from 0.10 to 5.0 μm, and more preferably from 0.15 to 2.0 μm.

When the average particle diameter of the pigment is within the above range, an ultraviolet shielding function is excellent.

The average particle diameter of the pigment is a value obtained by observing the fluororesin layer with a scanning electron microscope, measuring the particle diameters of 20 particles randomly extracted, and averaging the particle diameters.

### (Titanium Oxide Composite Particles)

A proportion of titanium oxide in the titanium oxide composite particles is preferably 95% by mass or more, and more preferably 95.5% by mass or more, with respect to 100% by mass of the total mass of the titanium oxide composite particles (the total of the titanium oxide particles and the coating layer). When the proportion of titanium oxide is 95% by mass or more, an excellent ultraviolet shielding effect is exhibited in the fluororesin.

The upper limit of the proportion of titanium oxide in the titanium oxide composite particles is not particularly limited, but is, for example, 99.9% by mass.

A proportion of coating layer in the titanium oxide composite particles is preferably from 0.6 to 2.5% by mass, more preferably from 1.0 to 2.5% by mass, and still more preferably from 1.0 to 2.0% by mass with respect to 100% by mass of the total mass of the titanium oxide composite particles. When the proportion of the coating layer in the titanium oxide composite particles is 2.5% by mass or less, foaming streaks are less likely to occur during molding of the fluororesin layer, and a fluororesin layer having a good appearance is easily obtained.

The coating layer of the titanium oxide composite particles exhibits an effect of preventing aggregation between the composite particles and an effect of reducing the catalytic activity of titanium oxide by containing aluminum oxide.

A proportion of aluminum oxide in the titanium oxide composite particles is preferably from 0.6 to 2.5% by mass, more preferably from 1.0 to 2.5% by mass, and still more preferably from 1.0 to 2.0% by mass with respect to 100% by mass of the total mass of the titanium oxide composite particles. When the proportion of aluminum oxide in the titanium oxide composite particles is 2.5% by mass or less, foaming streaks are less likely to occur during molding of the fluororesin layer, and a fluororesin layer having a good appearance is easily obtained.

The coating layer of the titanium oxide composite particles may contain an inorganic component other than aluminum oxide. Examples of other inorganic components include phosphorus oxide, sodium oxide, silicon oxide, zirconium oxide, and cerium oxide. One type of the other inorganic component may be used alone, or two or more types thereof may be used in combination.

A total amount of the silicon oxide, the zirconium oxide, and the cerium oxide is preferably 1.0% by mass or less, and more preferably 0.8% by mass or less, with respect to 100% by mass of the total mass of the titanium oxide composite particles.

On the other hand, phosphorus oxide, particularly phosphate ions can be contained in any proportion as long as the total amount of phosphorus oxide and aluminum oxide is within a range of 4% by mass or less (preferably 3% by mass or less), with respect to 100% by mass of the total mass of the titanium oxide composite particles.

The coating layer of the titanium oxide composite particles may be a single layer or a multilayer.

When the coating layer of the titanium oxide composite particles contains an inorganic component other than aluminum oxide, the inorganic component may be contained in the same layer as aluminum oxide or in another layer.

Among the inorganic components, phosphorus oxide and sodium oxide may be contained in the aluminum oxide layer as impurities. When silicon oxide or zirconium oxide is contained, a silicon oxide layer or a zirconium oxide layer is preferably provided separately from the aluminum oxide layer. In this case, the aluminum oxide layer is preferably provided outside the other layers (silicon oxide layer or zirconium oxide layer).

The coating layer of the titanium oxide composite particles may have a surface treatment agent layer on the outermost layer.

Examples of the surface treatment agent constituting the surface treatment agent layer include an antioxidant and a hydrophobizing agent. When an antioxidant is used as the surface treatment agent, coloration during compounding can be prevented. When the hydrophobizing agent is used as the surface treatment agent, aggregation of the titanium oxide composite particles in the fluororesin layer can be suppressed.

As the antioxidant, a known antioxidant such as a phosphorus-based antioxidant, a phenol-based antioxidant, or a sulfur-based antioxidant can be used.

Examples of the hydrophobizing agent include a silane coupling agent having an alkyl group and a silicone compound.

Examples of the silane coupling agent include the above-described silane coupling agent (S1), and examples of the silicone compound include the above-described silicone compound (S2).

The hydrophobizing agent is preferably a silicone compound. In the case of using a silicone compound, the curing of the fluororesin layer scarcely proceeds even by long-term outdoor exposure, and the flexibility is easily maintained. The reason is not clear, but it is presumed that the silicone compound has an effect of inhibiting crystallization of the fluororesin.

When the surface treatment agent layer is provided, a proportion of the surface treatment agent layer in the titanium oxide composite particles is preferably from 0.3 to 2.5% by mass, and more preferably from 0.5 to 1.5% by mass with respect to the total mass of the composite particles before providing the surface treatment agent layer, that is, the total mass of particles (inorganic particles) composed of an inorganic component such as titanium oxide or aluminum oxide. When the proportion is 0.3% by mass or more, the effect of providing the surface treatment agent layer can be sufficiently obtained. When the proportion is more than 2.5% by mass, when the heat resistance of the surface treatment agent is low, a large amount of thermal decomposition product of the surface treatment agent is generated during film molding and adheres to the die, and there is a possibility that lip cleaning needs to be frequently performed.

As the titanium oxide composite particles, particles produced by a known production method may be used, or commercially available products may be used.

Examples of commercially available products that can be used as the titanium oxide composite particles include Ti-Pure (registered trademark) R-101, R-102, R-103, R-104, and R-350 manufactured by Chemours Company; TiONA (registered trademark) RCL-69 and TiONA (registered trademark) 188 manufactured by Millennium Inorganic Chemicals; 2230 and 2233 manufactured by Kronos Worldwide, Inc.; CR50 and CR63 manufactured by Ishihara Sangyo Kaisha, Ltd.; and CR470 manufactured by Tronox, and the like. These commercially available products may be further provided with a surface treatment agent layer.

The content amount of each component in the titanium oxide composite particles can be measured by using a scanning fluorescent X-ray analyzer (for example, ZSX Primus II manufactured by Rigaku Corporation) on the fluororesin layer.

A average particle diameter of the titanium oxide composite particles is preferably from 0.15 to 0.40 μm, and more preferably from 0.17 to 0.30 μm.

From the viewpoint of effectively suppressing the expression of the catalytic activity, the average particle diameter of the titanium oxide composite particles is preferably 0.15 μm or more in order to reduce the specific surface area of titanium oxide in the titanium oxide composite particles. When the average particle diameter is 0.40 μm or less, the ultraviolet shielding function is excellent.

The average particle diameter of the titanium oxide composite particles is a value obtained by observing the fluororesin layer with an electron microscope, measuring the particle diameters of 20 particles randomly extracted, and averaging the particle diameters.

### (Zinc Oxide Composite Particles)

As the pigment, zinc oxide composite particles having a coating layer containing at least silicon oxide on the surface of the zinc oxide particles may be used.

The zinc oxide composite particles are preferably used in combination with titanium oxide or titanium oxide composite particles. When the zinc oxide composite particles and the titanium oxide or titanium oxide composite particles are used in combination, the catalytic activity of titanium oxide can be sufficiently suppressed, and more excellent weather resistance can be obtained.

As such effects, it is considered that the zinc oxide composite particles function as an ultraviolet shielding agent to reduce the amount of ultraviolet rays incident on the titanium oxide or titanium oxide composite particles, and as an acid acceptor for hydrofluoric acid generated by photodecomposition of the fluororesin, thereby suppressing the chain progression of the photodecomposition reaction of the fluororesin by hydrofluoric acid, are exerted, and that these effects act synergistically.

One type of the zinc oxide composite particle may be used alone, or two or more types thereof may be used in combination.

A mass ratio of zinc oxide to silicon oxide (ZnO/SiO₂) in the zinc oxide composite particles is preferably from 40/60 to 85/15, more preferably from 50/50 to 85/15, still more preferably from 50/50 to 80/20, and particularly preferably from 60/40 to 80/20.

When ZnO/SiO₂ is within the above range, an effect of gradually and efficiently neutralizing hydrofluoric acid is exhibited, and an adhesive film having more excellent weather resistance is obtained.

When the mass ratio is the upper limit value or less, the neutralization effect on hydrofluoric acid tends to be maintained for a long time. When the mass ratio is the lower limit value or more, aggregation between the zinc oxide composite particles is effectively suppressed.

The coating layer of the zinc oxide composite particles may contain an inorganic component other than silicon oxide. Examples of other inorganic components include phosphorus oxide, sodium oxide, aluminum oxide, zirconium oxide, and cerium oxide.

A total amount of zinc oxide and silicon oxide in the zinc oxide composite particles is preferably 80% by mass or more, and more preferably 85% by mass or more. When the total amount is 80% by mass or more, the above effect is sufficiently exhibited.

The coating layer of the zinc oxide composite particles may be a single layer or a multilayer.

When the coating layer of the zinc oxide composite particles contains an inorganic component other than silicon oxide, the inorganic component may be contained in the same layer as silicon oxide or in another layer.

Among the inorganic components, phosphorus oxide and sodium oxide may be contained in the silicon oxide layer as impurities. When aluminum oxide or zirconium oxide is contained, an aluminum oxide layer or a zirconium oxide layer is preferably provided separately from the silicon oxide layer. In this case, the aluminum oxide layer is preferably provided outside the other layers (aluminum oxide layer or zirconium oxide layer).

The coating layer of the zinc oxide composite particles may have a surface treatment agent layer on the outermost layer.

Examples of the surface treatment agent constituting the surface treatment agent layer include those described above.

When the surface treatment agent layer is provided, a proportion of the surface treatment agent layer in the zinc oxide composite particles is preferably from 1 to 5% by mass, and more preferably from 1.5 to 4% by mass with respect to the total mass of the zinc oxide composite particles before providing the surface treatment agent layer, that is, the total mass of particles (inorganic particles) composed of an inorganic component such as zinc oxide or silicon oxide. When the proportion is 1% by mass or more, the effect of providing the surface treatment agent layer can be sufficiently obtained. When the proportion is 5% by mass or less, generation of a thermal decomposition product of the surface treatment agent is effectively suppressed during film molding.

As the zinc oxide composite particles, those produced by a known production method may be used, or commercially available products may be used.

The zinc oxide composite particles are obtained, for example, by a method of coating zinc oxide particles having a surface area of from 25 to 50 m²/g with silicon oxide. Examples of the method of coating with silicon oxide include a method using a sol-gel reaction using alkoxysilane, a method of producing from water glass (for example, Japanese Patent Application Laid-Open (JP-A) No. H11-256133), and the like.

Examples of a commercially available product that can be used as the zinc oxide composite particles include MZ-510HPSX (ZnO/SiO₂=83/17) manufactured by TAYCA CORPORATION. These commercially available products include those subjected to a hydrophobic treatment, but a surface treatment agent layer may be further provided.

When the titanium oxide composite particles and the zinc oxide composite particles are contained, a total content amount of the titanium oxide composite particles and the zinc oxide composite particles in the fluororesin layer is preferably from 1.0 to 15.0% by mass, and more preferably from 2.0 to 13.0% by mass. A content amount of the zinc oxide composite particles in the fluororesin layer is preferably from 0.05 to 0.5% by mass, and more preferably from 0.1 to 0.3% by mass.

When the content amount of the zinc oxide composite particles is 0.05% by mass or more with respect to the fluororesin, hydrofluoric acid generated by decomposition of the fluororesin in the process of exposing the fluororesin layer to light can be sufficiently neutralized.

When the content amount of the zinc oxide composite particles is 0.5% by mass or less with respect to the fluororesin, the content amount of silicon oxide is sufficiently reduced, and accordingly, foamed streaks are less likely to occur during film molding, and a fluororesin layer having a good appearance is easily obtained.

The content amount of each component in the zinc oxide composite particles can be measured by using a scanning fluorescent X-ray analyzer (for example, ZSX Primus II manufactured by Rigaku Corporation). It is preferable to measure the content amount using a press sheet of zinc oxide composite particles.

A average particle diameter of the zinc oxide composite particles is preferably from 0.1 to 5 μm, and more preferably from 0.2 to 2 μm. When the average particle diameter is 0.1 μm or more, the use of the surface hydrophobizing agent can be effectively suppressed, and the occurrence of streak defects during film molding can be effectively suppressed. When the average particle diameter is 5 μm or less, the film is excellent in surface smoothness.

### (Cerium Oxide Composite Particles)

Cerium oxide composite particles may be used as a pigment. The cerium oxide composite particles have a three-layer structure of amorphous silica-cerium oxide-carrier from the outermost layer. One type of cerium oxide composite particles may be used alone, or two or more types thereof may be used in combination.

The carrier in the cerium oxide composite particles usually has a refractive index of light of approximately from 1.5 to 1.6. Examples of the carrier include silica, talc, and mica.

One type of the carrier may be used alone, or two or more types thereof may be used in combination.

In addition, when the amount of cerium oxide coating on the particle surface of the carrier is the same, the ultraviolet ray cutting ability is almost the same regardless of the carrier, but the effect of light diffusion varies depending on the type of carrier. Therefore, by using one type of carrier alone or in combination and dispersing the carrier in a fluororesin, it is possible to mold a fluororesin film having various ultraviolet cutting capabilities and light diffusing capabilities.

As the carrier, one having an average particle diameter of from 1 to 3 μm is used. The average particle diameter as used herein refers to the particle diameter at which the cumulative amount from a small particle side reaches 50%, as measured with a laser diffraction/scattering particle size distribution analyzer.

In general, when the average particle diameter of the carrier is 1 μm or more, the light diffusion effect is excellent, and when the average particle diameter is 3 μm or less, the reflected light and the absorbed light are moderately suppressed, and the light transmittance is excellent.

The particles in which the particle surface of the carrier is coated with cerium oxide may be produced by coating the carrier particles with an insoluble cerium compound. The insoluble cerium compound is a cerium compound insoluble in water, and examples thereof include cerium hydroxide, cerium phosphate, and cerium carbonate. Among them, cerium hydroxide is preferable.

The amorphous silica is silica having no crystallinity, and specific examples thereof include amorphous silica obtained by hydrolyzing sodium silicate.

An amount of the amorphous silica is preferably from 10 to 50 parts by weight with respect to 100 parts by weight of the carrier coated with the insoluble cerium compound. When the amount is 10 parts by weight or more, uniformity of coating of the surface of cerium oxide is excellent, and when the amount is 50 parts by weight or less, generation of aggregates of only amorphous silica is suppressed.

The content amount of each component in the cerium oxide composite particles can be measured by using a scanning fluorescent X-ray analyzer (for example, ZSX Primus II manufactured by Rigaku Corporation). It is preferable to measure the content amount using a press sheet of the cerium oxide composite particles.

The cerium oxide composite particles may be prepared by obtaining carrier particles having surfaces coated with an insoluble cerium compound and further coated with amorphous silica, and then calcining the particles.

An average particle diameter of primary particles of the obtained cerium oxide composite particles is preferably from 10 to 1000 nm, more preferably from 50 to 500 nm, and still more preferably from 100 to 200 nm.

Ane average particle diameter of the secondary particles of the obtained cerium oxide composite particles is preferably from 0.1 to 10 μm, and more preferably from 1 to 4 μm.

The average particle diameter of the primary particles and the average particle diameter of the secondary particles of the cerium oxide composite particles are measured using a laser diffraction/scattering particle size distribution analyzer, and refer to the particle diameter at which the cumulative value from the small particle side reaches 50%.

By coating the cerium oxide layer with the amorphous silica, the catalytic action of cerium oxide can be weakened, and thermal degradation and photodegradation of the fluororesin can be suppressed. In addition, when the cerium oxide composite particles are kneaded and dispersed in a fluororesin to mold a fluororesin film, coloring of the fluororesin film can be prevented, and dispersibility can be improved.

From the viewpoint of suppressing aggregation of the cerium oxide composite particles during melt-kneading with the fluororesin, it is preferable to treat the surface of the cerium oxide composite particles with a surface treatment agent. Examples of the surface treatment agent include those described above.

A content amount of the cerium oxide composite particles is preferably in the range of from 0.1 to 5 parts by weight, more preferably from 0.2 to 2 parts by weight, with respect to 100 parts by weight of the fluororesin, but may be in the range of from 0.4 to 5 parts by weight or from 0.5 to 3 parts by weight.

### [Adhesive Layer]

The adhesive layer contains an aminosilane coupling agent. One type of the aminosilane coupling agent may be used alone, or two or more types thereof may be used in combination.

The aminosilane coupling agent may have one or more amino groups, or may have two or more amino groups.

Examples of the aminosilane coupling agent include a compound represented by the following general Formula (1).

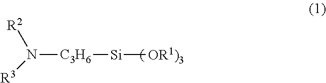

In Formula (1), R¹ represents an alkyl group, and R² and R³ each independently represent a hydrogen atom, an alkyl group, an aminoalkyl group, a phenyl group, or an aminocarbonyl group.

The alkyl group as R¹ preferably has 1 to 3 carbon atoms, and preferably has 1 or 2 carbon atoms.

The aminoalkyl group as R² and R³ is preferably an aminomethyl group, an aminoethyl group, or an aminopropyl group. The aminoalkyl group may have a substituent. Examples of the substituent include a phenyl group.

The alkyl group as R² and R³ may have a substituent. Examples of the substituent include a phenyl group and a vinylphenyl group.

The phenyl group as R² and R³ may have a substituent. Examples of the substituent include a vinyl group.

As examples of aminosilane coupling agents, N-(2-aminoethyl)-3-aminopropylmethyldimethoxysilane, N-(2-aminoethyl)-3-aminopropyltrimethoxysilane, N-(2-aminoethyl)-3-aminopropylmethyldiethoxysilane, N-(2-aminoethyl)-3-aminopropyltriethoxysilane, 3-aminopropyltrimethoxysilane, 3-aminopropyltriethoxysilane, 3-aminopropylmethyldimethoxysilane, 3-aminopropylmethyldiethoxysilane, N-phenyl-3-aminopropyltrimethoxysilane, N-phenyl-3-aminopropyltriethoxysilane, N-phenyl-3-aminopropylmethyldimethoxysilane, or N-phenyl-3-aminopropylmethyldiethoxysilane are preferable. From the viewpoint of obtaining stable adhesive strength, 3-aminopropyltrimethoxysilane, 3-aminopropyltriethoxysilane, or 3-aminopropylmethyldimethoxysilane are more preferable.

An amount of amino groups contained in the adhesive layer is preferably from 0.01 to 2.5 mmol/m², more preferably from 0.015 to 1.0 mmol/m², and still more preferably from 0.05 to 0.7 mmol/m². When the amino group equivalent is 0.01 mmol/m² or more, adhesiveness to the resin substrate is more excellent. When the amino group equivalent is 2.5 mmol/m² or less, an unnecessary increase in the amount of the aminosilane coupling agent used is suppressed.

From the viewpoint of more excellent adhesiveness to the substrate, the amount of amino groups contained in the adhesive layer is preferably in the same range as described above, and from the viewpoint of suppressing the influence of water vapor transmission, the amount of amino groups contained in the adhesive layer is preferably 1.0 mmol/m² or less, more preferably 0.7 mmol/m² or less, and still more preferably 0.20 mmol/m² or less.

The amount of the functional group of the silane coupling agent contained in the adhesive layer is determined from the following theoretical value.

Theoretical value: When a coating solution containing a silane coupling agent (solid content) is applied with a bar coater and dried to form an adhesive layer, the theoretical value is obtained by dividing the numerical value obtained by multiplying the wire number of the bar coater by 2.29 and the concentration (=mass of the silane coupling agent/mass of the coating solution) by the molecular weight of the silane coupling agent.

A content amount of the aminosilane coupling agent contained in the adhesive layer is preferably from 0.001 to 1.0 g/m², more preferably from 0.003 to 0.50 g/m², and still more preferably from 0.01 to 0.05 g/m².

The content amount of the aminosilane coupling agent contained in the adhesive layer is determined from the following theoretical value.

Theoretical value: When a coating solution containing an aminosilane coupling agent (solid content) is applied with a bar coater and dried to form an adhesive layer, the theoretical value is obtained by multiplying the number of the bar coater (wire number) by 2.29 and the concentration (=mass of the aminosilane coupling agent/mass of the coating solution).

A average thickness of the adhesive layer is preferably 1 μm or less, more preferably 0.5 μm or less, more preferably 0.1 μm or less, and still more preferably 0.05 μm or less from the viewpoint of improving adhesive strength. From the viewpoint of exhibiting adhesiveness, the average thickness of the adhesive layer is preferably 0.001 μm or more, more preferably 0.003 μm or more, and still more preferably 0.01 μm or more.

When a coating solution containing an aminosilane coupling agent (solid content) is applied with a bar coater and dried to form an adhesive layer, the average thickness of the adhesive layer is obtained by multiplying the number of the bar coater (wire number) by 2.29 and the concentration (=mass of aminosilane coupling agent/mass of coating solution), and dividing the result by the specific gravity of the silane coupling agent.

The adhesive layer may further contain a leveling agent, a solvent, or the like in addition to the aminosilane coupling agent. A solvent that serves to dilute a silane coupling agent having a functional group to improve coatability when forming the adhesive layer is usually removed by drying, but may remain in the adhesive layer.

As the solvent, any solvent may be used as long as the solvent can dissolve or disperse the silane coupling agent having a functional group. Examples thereof include: aromatic hydrocarbons such as benzene, toluene, and xylene; alicyclic hydrocarbons such as cyclohexane; aliphatic hydrocarbons such as hexane and octane; ethers, ketones, and esters such as diacetone alcohol, diethylene glycol, butyl carbitol, isophorone, acetone, methyl ethyl ketone, methyl isobutyl ketone, cyclohexanone, 4-hydroxy-4-methyl-2-pentanone, and ethyl acetate; halogenated hydrocarbons such as dichloromethane and carbon tetrachloride; organic solvents containing two or more functional groups such as dimethylformamide, butyl carbitol acetate, and diethanolamine; and monohydric or polyhydric alcohols such as methanol, ethanol, propanol, 2-propanol, butanol, 2-methyl-1-propanol, and ethylene glycol. One type of the solvent may be used alone, or two or more types thereof may be used in combination.

### [Resin Substrate]

The resin substrate contains an ultraviolet absorber and a resin. One type of the resin may be used alone, or two or more types thereof may be used in combination.

The resin contained in the resin substrate may be either a thermosetting resin or a thermoplastic resin, and examples thereof include polymethylpentene, syndiotactic polystyrene, polycycloolefin, silicone rubber, a polyester elastomer, polyethylene terephthalate, polybutylene terephthalate, unstretched nylon, polycarbonate, polyvinyl chloride, an epoxy resin, an acrylic resin, an ethylene-vinyl acetate copolymer resin, modified polyethylene obtained by blending a crosslinking agent with polyethylene, and a fiber-containing resin. Examples of the fibers in the fiber-containing resin include glass fibers and carbon fibers. Examples of the fiber-containing resin include a glass epoxy resin which is a glass fiber composite material, a carbon fiber reinforced plastic (CFRP) which is a carbon fiber composite material, and a carbon fiber reinforced thermoplastic (CFRTP).

Among them, the resin contained in the resin substrate preferably contains at least one selected from the group consisting of an ethylene-vinyl acetate copolymer resin and a modified polyethylene resin from the viewpoint of kneadability with an ultraviolet absorber.

Examples of the resin contained in the resin substrate include rubbers such as butyl rubber, natural rubber, styrene butadiene rubber (SBR), chloroprene rubber (CR), nitrile rubber (NBR), and ethylene propylene rubber (EPDM).

Examples of the ultraviolet absorber contained in the resin substrate include benzophenone-based ultraviolet absorbers, triazine-based ultraviolet absorbers, and benzotriazole-based ultraviolet absorbers, and are appropriately selected according to compatibility with the resin and a wavelength to be absorbed.

Examples of commercially available products of the ultraviolet absorber include ADK STAB LA-24, ADK STAB LA-29, ADK STAB LA-31RG/ADK STAB LA-31G, ADK STAB LA-32, ADK STAB LA-36/ADK STAB LA-36RG, ADK STAB LA-46, ADK STAB LA-F70, and ADK STAB 1413 (As described above, ADEKA Corporation).

A content amount of the ultraviolet absorber in the resin substrate is preferably from 0.01 to 0.50% by mass, more preferably from 0.05 to 0.30% by mass, and still more preferably from 0.10 to 0.20% by mass.

A total content of the ultraviolet absorber and the resin in the resin substrate is preferably 99% by mass or more, more preferably 99.5% by mass or more, and still more preferably 99.9% by mass or more.

A transmittance (ultraviolet transmittance) of the resin substrate at a wavelength of from 300 to 400 nm is preferably from 0.00001 to 1.0%, more preferably from 0.0001 to 0.01%, and still more preferably from 0.001 to 0.001%.

A average thickness of the resin substrate is not particularly limited, and is selected according to various applications. For example, the average thickness of the resin substrate may be from 50 to 1000 μm, from 100 to 800 μm, or from 200 to 500 μm.

When the average thickness of the resin substrate can be measured with a micrometer, the average thickness is determined by measuring the cross section of the resin substrate at five points with a microscope and calculating the average value.

The resin substrate containing the ultraviolet absorber may be obtained by manufacturing, or a commercially available product may be used. Examples of the commercially available product include an ethylene-vinyl acetate copolymer resin substrate (FIRSTEVAF806 manufactured by Foster Corporation) and a modified polyethylene substrate (Product name: Linklon XLE815N, manufactured by Mitsubishi Chemical Corporation).

### [Layer Structure of Laminate and Method of Producing Laminate]

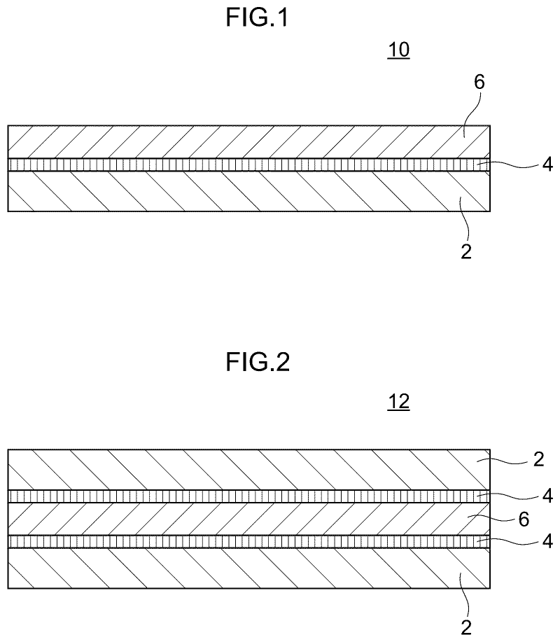

FIG. 1 is a schematic cross-sectional view showing an example of a laminate of the disclosure.

A laminate 10 of FIG. 1 is provided with a fluororesin layer 2, an adhesive layer 4, and a resin substrate 6 in this order. An antifouling layer (not shown) may be provided on the outer surface of at least one of the fluororesin layer 2 and the resin substrate 6. Further, other layers such as an undercoat layer (not shown) may be provided.

FIG. 2 is a schematic cross-sectional view showing another example of the laminate of the disclosure.

A laminate 12 of FIG. 2 is provided with the fluororesin layer 2, the adhesive layer 4, the resin substrate 6, the adhesive layer 4, and the fluororesin layer 2 in this order. An antifouling layer (not shown) may be provided on at least one outer surface of the fluororesin layer 2. Examples of the antifouling layer include a water-repellent layer, an oil-repellent layer, a fingerprint preventing layer, and a hydrophilic layer. In particular, the hydrophilic layer is preferable. Further, other layers such as an undercoat layer (not shown) may be provided.

In the laminate 12 of FIG. 2, the two fluororesin layers 2 may be the same or different. The two adhesive layers 4 may be the same or different.

The method of producing the laminate of the disclosure is not particularly limited, and examples thereof include a method in which a coating liquid containing an aminosilane coupling agent is applied to a fluororesin film containing ETFE to form an adhesive layer, and a resin substrate containing an ultraviolet absorber and a resin is laminated on the adhesive layer.

The coating liquid containing the aminosilane coupling agent may be a dispersion liquid or a solution. The concentration of the coating liquid containing the aminosilane coupling agent is preferably appropriately adjusted in consideration of viscosity and the like. Usually, the solvent is contained in an amount of from 10 to 100 parts by mass with respect to 10 parts by mass of the aminosilane coupling agent, but the disclosure is not limited thereto. The leveling agent is contained in an amount of from 0.01 to 0.10 parts by mass with respect to 10 parts by mass of the aminosilane coupling agent, but the disclosure is not limited thereto. The content amount of other components optionally contained is also appropriately adjusted.

The method of applying the coating liquid to the fluororesin film is not particularly limited, and examples thereof include various printing methods such as screen printing, a spin coating method, a brush coating method, a spray method, a doctor blade method, a roll coating method, an inkjet method, a micro-gravure method, and a direct gravure method. Among them, a spin coating method, a bar coating method, and a micro-gravure coating method capable of coating with a small amount are preferable.

Before applying the coating liquid, the surface of the fluororesin film on which the adhesive layer is provided may be subjected to a surface treatment in advance. By performing the surface treatment, the adhesive strength between the adhesive layer and the fluororesin film tends to be further improved.

The surface treatment is not particularly limited, and examples thereof include a corona discharge treatment, a plasma discharge treatment, a UV ozone treatment, a flame treatment, a chemical conversion treatment, and a primer treatment. A preferable surface treatment method is selected according to the type of the substrate, but from the viewpoint of ease of introduction of an industrial process, corona discharge treatment or plasma discharge treatment is preferable, and corona discharge treatment is more preferable.

A surface wetting index of the surface-treated fluororesin film is preferably 30 mN/m or more, and more preferably 40 mN/m or more. The upper limit of the wet tension is not particularly limited, and may be 60 mN/m or less.

The surface wetting index of the substrate is a value measured in accordance with JIS K6768:1999 using a wetting index reagent manufactured by FUJIFILM Wako Pure Chemical Corporation.

The method of laminating the fluororesin film having an adhesive layer and the resin substrate via the adhesive layer is not particularly limited, and examples thereof include a laminating method using a hand roller in a normal temperature/normal pressure state and a laminating method by heating and pressurizing in a vacuum state. From the viewpoint of suppressing a decrease in adhesive strength or a decrease in strength of the article due to air bubbles between the adhesive layer and the resin substrate, it is preferable to use a hand roller or a brush or remove the air bubbles in a vacuum state.

### [Physical Properties of Laminates and the Like]

An adhesive strength at the interface between the adhesive layer and the resin substrate is preferably 6.0 N/cm or more, more preferably 9.0 N/cm or more, and still more preferably 10.0 N/cm or more.

An adhesive strength of the interface between the adhesive film and the resin substrate after a weather resistance test is preferably 6.5 N/cm or more, more preferably 8.0 N/cm or more, and still more preferably 9.5 N/cm or more.

A ratio of the adhesive strength before and after a weather resistance test (adhesive strength after weather resistance test/adhesive strength before weather resistance test) is preferably 0.35 or more, more preferably 0.40 or more, and still more preferably 0.50 or more.

As the ratio of the adhesive strength is closer to 1, the initial adhesive strength set according to the application of the laminate is maintained even after a weather resistance test.

The adhesive strength is tested under the conditions of 180° C. and 50 mm/min using a Tensilon universal material testing machine (RTC-1210A manufactured by A&D Company, Limited), and after the start of the test, the average value of the peel strength at 20 mm for a moving distance of from 10 to 30 mm is calculated as the adhesive strength.

In the weather resistance test, the laminate is cut into a size of 15 cm×7 cm to prepare an evaluation sample, and the sample is put in a weather resistance acceleration test apparatus (for example, Eye Super UV Tester, manufactured by Iwasaki Electric Co., Ltd.) and tested. The sample was exposed for 500 hours by repeating the following cycle (one cycle is 12 hours and 20 seconds) while irradiating ultraviolet rays having a wavelength of 300 to 450 nm and an intensity of 1500 mW/cm²: (i) irradiation with ultraviolet rays for 10 hours under the conditions of a BP (black panel) temperature of 63° C. and a relative humidity of 50% RH, (ii) shower for 10 seconds, (iii) dark dew condensation state for 2 hours under the conditions of a BP temperature of 30° C. and a relative humidity of 100% RH, and (iv) shower for 10 seconds. Ultraviolet irradiation of the test specimen was performed from the fluororesin layer side.

The visible light transmittance from the fluororesin layer to the adhesive layer in the laminate is preferably 85% or more, more preferably 87% or more, still more preferably 90% or more, and particularly preferably 92% or more. In the case of use in an agricultural house, a front sheet of a solar cell module, an article considering designability, or the like, it is preferable that the visible light transmittance is high, but when the visible light transmittance is 85% or more, transparency is excellent, and a function in each application is exhibited.

The visible light transmittance in the disclosure is measured in accordance with DIN EN410 1998.

In the laminate of the disclosure, an uneven structure may be imparted to at least one surface. When the uneven structure is imparted to the surface of the laminate, light is scattered in the laminate.

The arithmetic mean roughness Ra of the surface having the uneven structure is preferably from 0.3 to 3.0 μm, more preferably from 0.8 to 3.0 μm, and still more preferably from 1.0 to 2.5 μm. Further, the depth of the unevenness may be set shallower. In this case, Ra is preferably from 0.3 to 2.0 μm, more preferably from 0.8 to 1.8 μm, and still more preferably from 1.0 to 1.6 μm. On the other hand, the depth of the unevenness may be set to be deep. In this case, Ra is preferably from 0.6 to 3 μm, more preferably from 1.7 to 3 μm, and still more preferably from 1.8 to 2.5 μm.

The maximum height roughness Rz of the surface having the uneven structure is preferably from 1 to 25 μm, more preferably from 4 to 25 μm, and still more preferably from 4 to 22 μm. When the depth of the unevenness is set to be shallow, Rz is preferably from 1 to 8 μm, more preferably from 4 to 7 μm, and still more preferably from 4 to 6 μm. When the depth of the unevenness is set to be deep, Rz is preferably from 13 to 25 μm, more preferably from 15 to 25 μm, and still more preferably from 18 to 22 μm.

The arithmetic mean roughness Ra and the maximum height roughness Rz are values measured by a method described in JIS B0601:2013 (ISO4287:1997, Amd. 1:2009).

### [Application]

Since the laminate of the disclosure is excellent in long-term weather resistance, the laminate is suitably used indoors and outdoors. Examples of applications of the laminate include agricultural greenhouses, architectural exterior materials, front sheets of solar cell modules, CFRP laminates such as wind power generation blades and aircraft, CFRTP laminates, exterior materials for vehicles, exterior materials for ships, exterior materials for aerospace mobile bodies such as rockets and balloons, communication infrastructure, interior materials, digital signage, signboards, and medical rubber stoppers.

In addition, the laminate of the disclosure can also increase the visible light transmittance from the fluororesin layer to the adhesive layer, and is suitably used as at least one selected from the group consisting of protective films for front sheets of solar cell modules, protective films for digital signage, protective films for signboards, protective films for medical rubber stoppers, and protective films for interior materials.

The laminate of the disclosure in which the resin substrate contains rubber is particularly suitable for use as a laminated rubber stopper for sealing the opening of a container. Examples of the laminated rubber stopper include a top plate portion having an outer diameter larger than an inner diameter of the container opening, and a cylindrical leg portion protruding from a lower surface of the top plate portion in contact with the container opening and defining and forming a hollow internal space, and the lower surface of the top plate portion and the leg portion are coated with the resin film.

The laminated rubber stopper can be used as a medical rubber stopper.

Examples of the use of the container to which the laminated rubber stopper is applied include a vial for medical liquid medicine, a vial for specimen storage, and a storage bottle for chemicals, solvents, and the like. Examples of the material of the container include glass, polystyrene, polypropylene, acrylic, and fluorine resins.

The laminated rubber stopper is obtained, for example, by laminating an adhesive film in which a coating liquid containing an aminosilane coupling agent is applied to a fluororesin film to form an adhesive layer and a rubber material containing a crosslinking agent on a cavity in a mold having a predetermined rubber stopper shape, and heating and pressurizing the laminate at 150° C. or higher.

When the laminate of the disclosure is used for a laminated rubber stopper, it is preferable to use the fluororesin film described in International Patent Publication 2017/082315 as the fluororesin layer.

### <Adhesive Film>

The laminate of the disclosure may be obtained by using an adhesive film including a fluororesin layer containing an ethylene-tetrafluoroethylene copolymer and an adhesive layer containing an aminosilane coupling agent. The fluororesin layer and the adhesive layer in the adhesive film are the same as the fluororesin layer and the adhesive layer in the above-described laminate.

The adhesive film used in the laminate of the disclosure may include a fluororesin layer containing an ethylene-tetrafluoroethylene copolymer and an adhesive layer containing an aminosilane coupling agent, and may have a visible light transmittance of 85% or more. As described above, since the adhesive film includes the fluororesin layer and the adhesive layer having high visible light transmittance, the adhesive film can be suitably used for at least one selected from the group consisting of protective films for front sheets of solar cell modules, protective films for digital signage, protective films for signboards, protective films for medical rubber stoppers, and protective films for interior materials. That is, the adhesive film used for the laminate of the disclosure may be one that includes a fluororesin layer containing an ethylene-tetrafluoroethylene copolymer and a layer containing an aminosilane coupling agent, and is used for at least one selected from the group consisting of protective films for front sheets of solar cell modules, protective films for digital signage, protective films for signboards, protective films for medical rubber stoppers, and protective films for interior materials.

### EXAMPLES

Hereinafter, the invention will be described in detail with reference to Examples and Comparative Examples, but the invention is not limited to these Examples.

Examples 1 to 5 and Example 8 are examples, and Examples 6 to 7 and Example 9 are comparative examples.

### Example 1

### (Preparation of Adhesive Film)

An adhesive liquid containing 3.00% by mass of a silane coupling agent having a primary amino group as an organic functional group (Product name “KBM-903”, manufactured by Shin-Etsu Chemical Co., Ltd.), 0.05% by mass of a leveling agent (Product name “Surfynol 420”, manufactured by Shin-Etsu Chemical Co., Ltd.), and 96.95% by mass of industrial ethanol (Product name: “Solmix AP-1”, manufactured by Nippon Alcohol Trading Co., Ltd.) was prepared.

When one surface of an ETFE film (manufactured by AGC Inc., trade name: AFLEX 50N) having an average thickness of 50 μm was subjected to a corona discharge treatment, the surface wetting index was 42 mN/m. Thereafter, the corona discharge-treated surface was coated with an adhesive liquid by a bar coating method using a No. 5 bar, and the coated fluororesin film was dried at 80° C. for 5 seconds. As a result, an adhesive layer having a coating thickness of 0.34 μm and a coating amount of 0.34 g/m² was formed to obtain an adhesive film.

The amount of amino groups in the adhesive layer was measured by the above-described method.

The transmittance (%) of the used ETFE film at 360 nm was measured in accordance with DIN EN410 1998 using an ultraviolet-visible-near-infrared spectrophotometer (Shimadzu Corporation, UV-PC3600 measuring instrument).

The visible light transmittance (%) of the obtained adhesive film (from the fluororesin layer to the adhesive layer) was measured in accordance with DIN EN410 1998 using an UV-PC3600 measuring instrument of Shimadzu Corporation.

### (Preparation of Laminate)

The obtained adhesive film was cut into a size of 8 cm×15 cm.

In addition, 3 sheets of 50 cm square PTFE glass cloth and 1 sheet of 40 cm square tempered glass were prepared.

As the EVA substrate, trade name: FIRSTEVA F806 (average thickness: 400 μm) containing an ultraviolet absorber manufactured by Foster Corporation was used. As the ultraviolet absorber, 2-hydroxy-4-n-octyloxybenzophenone is contained in an amount of from 0.1 to 1% by mass.

One surface of an ETFE film (manufactured by AGC Inc., trade name: AFLEX 50N) having an average thickness of 50 μm was subjected to atmospheric pressure plasma treatment.

As a vacuum laminator device, a solar cell module laminator LM-50S manufactured by NPC was used. On a 50 cm square table heated to 145° C., PTFE glass cloth/tempered glass/PTFE glass cloth/adhesive film (adhesive layer on EVA substrate side)/EVA substrate/ETFE film (plasma treated surface on EVA substrate side)/PTFE glass cloth was laminated in this order. In this state, the sample was evacuated, preheated for 3 minutes, then pressurized at 100 Ps for 15 minutes, then returned to the atmospheric pressure state, and taken out after confirming that the sample temperature was 40° C. or lower. Thus, a laminate of fluororesin layer/adhesive layer/EVA substrate/fluororesin layer was obtained.

### (Evaluation of Initial Adhesive Strength)

The obtained laminate was cut into a width of 10 mm to prepare an evaluation sample. This evaluation sample was subjected to a peeling test by a 1800 peeling method at 50 mm/min under the condition of 180° C. using a Tensilon universal material testing machine (RTC-1210A manufactured by A&D Company, Limited). After the start of the test, the average value of the peel strength at 20 mm within the 10 to 30 mm movement distance was calculated as the adhesive strength.

### (Evaluation of Long-Term Weather Resistance Test)

The obtained laminate was cut into a size of 5 cm×3 cm to prepare an evaluation sample. This evaluation sample was placed in a weather resistance acceleration test device (Eye Super UV Tester manufactured by Iwasaki Electric), and exposed for 500 hours (SUV 500 hours) by repeating the following cycle (one cycle is 12 hours and 20 seconds) while irradiating ultraviolet rays having a wavelength of 300 to 450 nm and an intensity of 1500 mW/cm²: (i) irradiation with ultraviolet rays for 10 hours under the conditions of a BP (black panel) temperature of 63° C. and a relative humidity of 50% RH, (ii) shower for 10 seconds, (iii) dark dew condensation state for 2 hours under the conditions of a BP temperature of 30° C. and a relative humidity of 100% RH, and (iv) shower for 10 seconds. Ultraviolet irradiation of the test specimen was performed from the ETFE film side.

For the evaluation samples after exposure, the adhesive strength was measured in the same manner as described above.

### Examples 2 to 4

A laminate was obtained in the same manner as in Example 1 except that the concentration of the aminosilane coupling agent in the adhesive liquid was changed as shown in Table 1 and adjusted with the amount of ethanol.

### Example 5

A laminate was obtained in the same manner as in Example 1 when the resin substrate was changed to a modified polyethylene substrate (manufactured by Mitsubishi Chemical Corporation, product name: Linklon XLE815N, average thickness: 400 μm, containing an ultraviolet absorber) and the concentration of the adhesive liquid was changed as shown in Table 1.

### Example 6

In the same manner as in Example 1, a laminate was obtained by laminating the corona discharge treated surface of the ETFE film and the EVA substrate in the same manner as in Example 1 when no adhesive layer was formed.

### Example 7

In the same manner as in Example 1, a laminate was obtained in the same manner as in Example 1 except that EVA (manufactured by Foster Corporation, trade name: FIRSTEVA F406 (average thickness: 400 μm)) not containing an ultraviolet absorber was used and the concentration of the adhesive liquid was changed as shown in Table 1.

### Example 8

A laminate was obtained in the same manner as in Example 2 when the fluororesin layer was changed to an ETFE film obtained by adding cerium oxide composite particles (the average particle diameter of the primary particles is from 100 to 200 nm, and the average particle diameter of the secondary particles is from 1 to 4 μm) in an amount of 0.6% by mass with respect to 100 parts by mass of ETFE and molding the obtained mixture to have an average thickness of 100 μm.

### Example 9

A laminate was obtained in the same manner as in Example 6, when the thickness of the fluororesin layer was changed to an average thickness of 100 μm and the resin substrate was changed to EVA (manufactured by Foster Corporation, trade name: FIRSTEVA F406 (average thickness: 400 μm)) not containing an ultraviolet absorber.

TABLE 1

| | | | Example 1 | Example 2 | Example 3 | Example 4 | Example 5 |
|---|---|---|---|---|---|---|---|
| Fluororesin | Substrate type | | ETFE50N | ETFE50N | ETFE50N | ETFE50N | ETFE50N |
| layer | Average thickness [μm] | | 50 | 50 | 50 | 50 | 50 |
| | 360 nm transmittance [% T] | | 85.0 | 85.0 | 85.0 | 85.0 | 85.0 |
| | Presence or absence of | | Present | Present | Present | Present | Present |
| | corona discharge treatment | | | | | | |
| | Surface wetting index | | 42 | 42 | 42 | 42 | 42 |
| | [mN/m] | | | | | | |
| Adhesive | Adhesive: aminosilane | | Present | Present | Present | Present | Present |
| layer | coupling agent | | | | | | |
| | Adhesive | Amount of | 3.00 | 0.30 | 0.15 | 0.03 | 0.30 |
| | liquid | aminosilane | | | | | |
| | | coupling agent | | | | | |
| | | [% by mass] | | | | | |
| | Adhesive | Amount of | 0.34 | 0.034 | 0.017 | 0.0034 | 0.034 |
| | layer | aminosilane | | | | | |
| | | coupling agent | | | | | |
| | | [% by mass] | | | | | |
| | | Amount of | 1.92 | 0.19 | 0.10 | 0.02 | 0.19 |
| | | amino group | | | | | |
| | | [mmol/m²] | | | | | |

| | Average thickness [μm] | 0.34 | 0.034 | 0.017 | 0.03 | 0.34 |
|---|---|---|---|---|---|---|
| Visible light transmittance from fluororesin | | 93.9 | 94.0 | 94.0 | 94.0 | 94.0 |
| layer to adhesive layer [%] | | | | | | |
| Resin | Type | EVA | EVA | EVA | EVA | Modified |
| substrate | | | | | | polyethylene |
| | Presence or absence of | Present | Present | Present | Present | Present |
| | ultraviolet absorber | | | | | |
| Evaluation: | Initial [N/cm] (a) | 19.6 | 19.4 | 18.7 | 17.5 | 20.5 |
| adhesive | After weather resistance | 10.1 | 10.0 | 9.6 | 9.0 | 11.2 |
| strength | test [N/cm] (b) | | | | | |
| | Adhesive strength ratio | 0.52 | 0.52 | 0.51 | 0.51 | 0.55 |
| | (b)/(a) | | | | | |

| | | Example 6 | Example 7 | Example 8 | Example 9 |
|---|---|---|---|---|---|
| Fluororesin | Substrate type | ETFE50N | ETFE50N | ETFE(CeO₂) | ETFE |
| layer | Average thickness [μm] | 50 | 50 | 100 | 100 |
| | 360 nm transmittance [% T] | 85.0 | 85.0 | 54.2 | 85.0 |
| | Presence or absence of | Present | Present | Present | Present |
| | corona discharge treatment | | | | |
| | Surface wetting index | 42 | 42 | 42 | 42 |
| | [mN/m] | | | | |
| Adhesive | Adhesive: aminosilane | None | Present | Present | None |
| layer | coupling agent | | | | |

| | | | |
|---|---|---|---|
| Adhesive | Amount of | 0.30 | 0.30 |
| liquid | aminosilane | | |
| | coupling agent | | |
| | [% by mass] | | |
| Adhesive | Amount of | 0.034 | 0.034 |
| layer | aminosilane | | |
| | coupling agent | | |
| | [% by mass] | | |
| | Amount of | 0.19 | 0.19 |
| | amino group | | |
| | [mmol/m²] | | |

| | Average thickness [μm] | | 0.034 | 0.034 | |
|---|---|---|---|---|---|
| Visible light transmittance from fluororesin | | 94.0 | 94.0 | 89.3 | 91.1 |
| layer to adhesive layer [%] | | | | | |
| Resin | Type | EVA | EVA | EVA | EVA |
| substrate | Presence or absence of | Present | Absent | Present | Absent |
| | ultraviolet absorber | | | | |
| Evaluation: | Initial [N/cm] (a) | 18.0 | 18.2 | 29.8 | 27.8 |
| adhesive | After weather resistance | 6.1 | 3.0 | 27.6 | 9.3 |
| strength | test [N/cm] (b) | | | | |
| | Adhesive strength ratio | 0.34 | 0.16 | 0.93 | 0.33 |
| | (b)/(a) | | | | |

The laminates of Examples 1 to 4 and Example 8 had excellent adhesive strength even after a weather resistance acceleration test for 500 hours.

Even when the material of the resin substrate was changed as in the laminate of Example 5, the adhesive strength was excellent after a weather resistance acceleration test for 500 hours.

On the other hand, in the laminates of Example 6 and Example 9 having no adhesive layer containing an aminosilane coupling agent, the initial adhesiveness was excellent, but the adhesive strength decreased after the weather resistance acceleration test for 500 hours. Since the plasma discharge treatment uses a special device, the plasma discharge treatment is more complicated than formation of an adhesive layer containing an aminosilane coupling agent, and is disadvantageous in terms of cost.

As shown in Example 7, when the resin substrate does not contain an ultraviolet absorber but an adhesive layer containing an aminosilane coupling agent is provided, the initial adhesiveness was excellent, but the adhesive strength decreased after the weather resistance acceleration test for 500 hours.

Since the laminate of Example 8 contained cerium oxide composite particles in the fluororesin layer, the laminate was excellent in adhesive strength even after the weather resistance acceleration test for 500 hours as compared with the laminate of Example 2.

### INDUSTRIAL APPLICABILITY

Since the laminate of the disclosure is excellent in long-term weather resistance, the laminate is suitably used for agricultural greenhouses, architectural exterior materials, front sheets of solar cell modules, CFRP laminates such as wind power generation blades and aircraft, CFRTP laminates, exterior materials for vehicles, exterior materials for ships, exterior materials for aerospace mobile bodies such as rockets and balloons, communication infrastructure, interior materials, digital signage, signboards, and medical rubber stoppers.

In addition, the laminate of the disclosure can also increase the visible light transmittance from the fluororesin layer to the adhesive layer, and is suitably used as at least one selected from the group consisting of protective films for front sheets of solar cell modules, protective films for digital signage, protective films for signboards, protective films for medical rubber stoppers, and protective films for interior materials.

### DESCRIPTION OF REFERENCE NUMERALS

2 Fluororesin layer
4 Adhesive layer
6 Resin substrate
10, 12 Laminate

The disclosure of Japanese Patent Application No. 2023-068088 is incorporated herein by reference in its entirety.

All publications, patent applications, and technical standards in the disclosure are incorporated in the present specification to the same extent as if each individual publication, patent application, and technical standard were specifically and individually noted to be incorporated by reference in the disclosure.

1. A laminate, comprising, in this order:
a fluororesin layer comprising an ethylene-tetrafluoroethylene copolymer;
an adhesive layer comprising an aminosilane coupling agent; and
a resin substrate comprising an ultraviolet absorber and a resin.

2. The laminate according to claim 1, wherein a visible light transmittance from the fluororesin layer to the adhesive layer is 85% or more.

3. The laminate according to claim 1, wherein the resin in the resin substrate includes at least one selected from the group consisting of an ethylene-vinyl acetate copolymer resin and a modified polyethylene resin.

4. The laminate according to claim 1, wherein a total content of the ultraviolet absorber and the resin in the resin substrate is 99% by mass or more.

5. The laminate according to claim 1, wherein an amount of amino groups contained in the adhesive layer is from 0.01 to 2.5 mmol/m².

6. The laminate according to claim 1, wherein an average thickness of the adhesive layer is 1 μm or less.

7. The laminate according to claim 1, wherein a content of the ethylene-tetrafluoroethylene copolymer in the fluororesin layer is 90% by mass or more.

8. The laminate according to claim 1, wherein the fluororesin layer further comprises a pigment.

9. The laminate according to claim 1, which is at least one selected from the group consisting of protective films for front sheets of solar cell modules, protective films for digital signage, protective films for signboards, and protective films for interior materials.

10. An adhesive film, comprising:
a fluororesin layer comprising an ethylene-tetrafluoroethylene copolymer; and
an adhesive layer comprising an aminosilane coupling agent, wherein
a visible light transmittance is 85% or more.

11. An adhesive film, comprising:
a fluororesin layer comprising an ethylene-tetrafluoroethylene copolymer; and
a layer comprising an aminosilane coupling agent, wherein:
the adhesive film is used for at least one selected from the group consisting of protective films for front sheets of solar cell modules, protective films for digital signage, protective films for signboards, protective films for medical rubber stoppers, and protective films for interior materials.
